(19) United States
(12) Patent Application Publication
(10) Pub. No.: US 2008/0221492 A1
(43) Pub. Date: Sep. 11, 2008

(54) Exercise stand and active/passive pedalling device

(76) Inventor: Avrahm El'Chonen, Oak Park, MI (US)

Correspondence Address: The Weintraub Group, P.L.C., Suite 240, 32000 Northwestern Highway, Farmington Hills, MI, 48334, US

(21) Appl. No.: 12/072,367

(22) Filed: Feb. 26, 2008

Related U.S. Application Data
(60) Provisional application No. 60/903,435, filed on Feb. 26, 2007.

(51) Int. Cl. A61H 1/00

(52) U.S. Cl. 601/36

(57) ABSTRACT

An active and passive motion device for therapeutic exercise of upper and lower extremities, in the form of a pedaling device for therapy of leg and associated articulations. The device comprises a combination exercise stand and active/passive pedaling device that enables users with and/or without motor skills to remain generally stationary and seated in a chair or wheel chair and use their legs to actively pedal the device or have their legs moved by the pedaling device. Disclosed in an aspect thereof is an improved ankle strap sandal for use in such therapy. A lift enables the pedaling device to be vertically positioned relative to the wheelchair user when atop the support stand.

### CROSS-REFERENCE TO RELATED APPLICATION

This application claims the benefit of U.S. Provisional Application No. 60/903,435, filed Feb. 26, 2007, the entire disclosure of which is incorporated herein in its entirety.

### BACKGROUND OF THE INVENTION

1. Field of the Invention

The present invention relates to active and passive motion devices for therapeutic exercise of upper and lower extremities, and more particularly, to a pedaling device for therapy of leg and associated articulations. More particularly, this invention relates to a combination exercise stand and active/passive pedaling device that enables users with and/or without motor skills to remain generally stationary and seated in a chair or wheel chair and use their legs to actively pedal the device or have their legs moved by the pedaling device. Even more particularly, this invention relates to an improved ankle strap sandal for use in such therapy

2. Description of Related Art

When human limbs are immobilized for prolonged periods of time, whether due to paralysis or to encasement in a cast, a condition known as osteoporosis can occur. Osteoporosis is a deossification with absolute decrease in bone tissue resulting in, among other things, structural weakness of the bone.

Further, rehabilitation and treatment of injured joints can be expedited by use of active and continuous passive motion (CPM) of the joint. Continuous passive motion entails inducing movement of certain limb portions without requiring muscle coordination, strength, or coordination by the patient. Studies have shown that CPM of the different limbs and joints accelerates healing, and very importantly results in a fuller range of motion of the joint at the end of the course of therapy. Passive exercise provides needed exercise for individuals with other non-permanent injuries such as fracture. The recovery cycle from a muscular skeletal injury progressively moves from a passive involvement to an active involvement range of motion.

Preferably, in many situations a device for therapeutic treatment of joints/limbs should enable the use by patients whether seated in a wheel chair or regular chair. Further, the device should also provide the patient with both a passive mode, in which the device exercises the limb, and an active mode, in which the patient uses the device to exercise the limb and joints once they become healthy enough.

Furthermore, patients have different leg lengths and foot requirements, and may have different seating requirements; the therapeutic device should be adjustable wherein to provide a range of horizontal and vertical motion to accommodate these different patient needs and requirements.

Various exercise and therapy devices wherein the patient is in operable relation with a pedaling device have been proposed. By way of example, attention is drawn to pedaling devices disclosed in U.S. Pat. No. 5,312,312, issued May 17, 1994 to Fernandez et al.; U.S. Pat. No. 6,179,746, issued Jan. 30, 2001 to Delman; U.S. Pat. No. 6,520,892, issued Feb. 18, 2003 to Hassler; U.S. Pat. No. 5,860,941, issued Jan. 19, 1999 to Saringer et al.; U.S. Pat. No. 6,837,831, issued Jan. 4, 2005 to Lee; and D 462,099, issued Aug. 27, 2002 to Chen; and U.S. Pat. Publication US 2003/0092536, published May 15, 2003 to Romanelli et al.

An arrangement wherein a chair is associated with an exercise apparatus is disclosed in U.S. Pat. No. 4,570,927, issued Feb. 18, 1986 to Petrofsky et al. and U.S. Pat. No. 5,472,396, issued Dec. 5, 1995 to Brazaitis.

Arrangements wherein a wheel chair is associated with an exercise apparatus is disclosed in U.S. Pat. No. 4,928,673, issued May 29, 1990 to Heneger and U.S. Pat. No. 6,755,768, issued Jun. 29, 2004 to Garcia-Rill et al.

Finally, motorized pedal exercisers are commercially available. One such pedal exerciser, sold under the name OxyCycle, is specially designed for those that have a hard time sitting on a regular bike and may be used from a regular chair or wheelchair.

However, while the above noted approaches are believed have provided a suitable solution to the problem(s) then needing a solution, there is an ongoing need for improvements in active/passive pedaling apparatus.

The above references are listed in recognition of the duty of disclosure of related subject matter which may be relevant as prior art under 37 CFR 1.56.

### SUMMARY OF THE INVENTION

An object of this invention is the provision of active/passive pedaling apparatus that is adjustable, both as to the relation of a pedaling device relative to the user chair and the pedaling device relative to the pedals wherein to accommodate feet or legs in order that the user may work out the legs. Desirably, such active/passive pedaling apparatus may be personalized to accommodate different users and provide a user with low impact work out or therapy exercise that is easy on the joints, promotes circulation, and is adjustable to provide different speeds to progressively strengthen arms and legs.

Another object of this invention is the provision of orthopedic shoe-like member that may be mounted to the pedal of a pedaling apparatus to make the fitment of the foot of the user relative to the pedal more comfortable

As an aspect of this invention, an object is the provision of a foot securement member that improves the ability of the leg to move through a therapy regimen that requires the leg to bend and be vertically disposed and extends outwardly and is horizontally disposed.

A further object of this invention is a therapy exercise arrangement adapted to adjustably position the feet of a user seated in a wheelchair with the pedals of an active/passive pedaling apparatus, the pedaling apparatus being stationary or movable both towards and away and/or vertically upwardly and downwardly relative to a platform upon which the wheelchair is secured.

A further object of this invention is the provision of a passive exercise system for inducing a cycling motion in the limbs or extremities of patients who have little or no motor control of their legs.

A further object of this invention is the provision in a passive exercise device of a foot securement arrangement that is adjustable to ensure that the feet of the patient are maintained in alignment with the cycling motion.

According to this invention and in fulfillment of the above and other objects, there is provided an exercise apparatus for providing both active and continuous passive motion of lower body extremities or legs of a user, comprising

a pedaling exerciser, said exerciser including a frame, a crankshaft having opposite ends, a pair of foot pedals, and a motor for rotating the crankshaft, said crankshaft mounted for rotation relative to the frame, and said foot pedals mounted on a respective end for rotation relative thereto,

a support stand to support a chair above and away from said exerciser and to position the feet and legs of the user relative to the pedals of said exerciser while seated in the chair, and

a pair of ankle strap sandals, said sandals respectively for one and the other of said pedals and restraining a respective foot of the user, each said sandal being connected to a respective of the pedals and selectively positionable relative to the axis of rotation of the pedal relative to the crankshaft end.

According to this invention, each ankle strap sandal comprises

a longitudinally elongated platform for supporting the base of the foot and an upstanding back for nesting the ankle of the foot relative to the platform,

restraining means for securely fastening the foot and ankle relative to the platform and the back in a manner that the mid-point of the foot is disposed between the opposite longitudinal ends of the platform, and

means for connecting the sandal to the pedal in a manner that the mid-point of the foot may be positioned where desired relative to the axis of rotation of the pedal wherein to orient the base of the foot and leg of the user in a manner to optimize the force transmitted to the leg and to exercise same upon rotation of the crank either actively by the user or passively by the motor.

In an embodiment thereof, the means for connecting comprises provision of a multi-chambered connector base, the base depending from the bottom of the platform, and said chambers being spaced in side-by-side relation and extending laterally of the platform. The chambers are adapted to be slipped over and about a respective pedal and, so mounted, orient the longitudinal axis of the platform to be orthogonal to the axis of the crankshaft end. Depending on the chamber selected, the mid-point of the foot may be centered atop the crankshaft end, or longitudinally forward or rearward thereof.

Further, the apparatus includes a controller for selectively disabling the motor to permit a user to physically rotate the crank, and actively exercise their legs, without motor assistance, and enabling the motor to rotate the crank and passively exercise the legs of the user.

Additionally, because of the difference in users body types, height, and the like, and whether confined to a wheel chair or other chair, the apparatus preferably includes means for positioning the pedaling exerciser relative to said support stand and the pedal crankshaft relative to the chair.

According to this aspect of the invention,

the support stand defines a first support surface for supporting the chair, which support surface is vertically above a horizontal ground plane, and

the means for positioning comprises a lift, and means for securing said exerciser atop said lift, said lift being disposed on and movable vertically relative to said ground plane.

In some applications, the means for positioning further is configured that the lift may be movable back and forth, generally horizontally, towards and away from said support stand. Such horizontal and vertical control of the position of the pedaling exerciser enables the pedals and the users feet to be more appropriately located for maximum therapy.

Desirably, the therapy system of the wheelchair being disposed above the pedaling exerciser enables vertical movement of the leg, as opposed to horizontal translation. In this regard, the removable foot sandal further complements the orientation of the leg and foot of the user relative to the pedal crank of the exerciser.

As an aspect of this invention, the ankle strap sandals, the back is generally V-shaped, to nest the ankle of the user, and securement straps are provided to secure the ankle firmly to the back and the foot firmly atop the platform.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view of exercise apparatus including a support stand supporting a wheel chair in operable relation to an active/passive pedaling exerciser fitted with specially configured sandals for exercising the legs of a user, according to this invention;

FIG. 2 is perspective view looking down at the active/passive pedaling exerciser as shown in FIG. 1 and an ankle strap sandal positioned for assembly to a respective of the exerciser pedals; and

FIG. 3 is perspective side elevation view of the ankle strap sandal according to this invention.

### DETAILED DESCRIPTION OF PREFERRED EMBODIMENTS

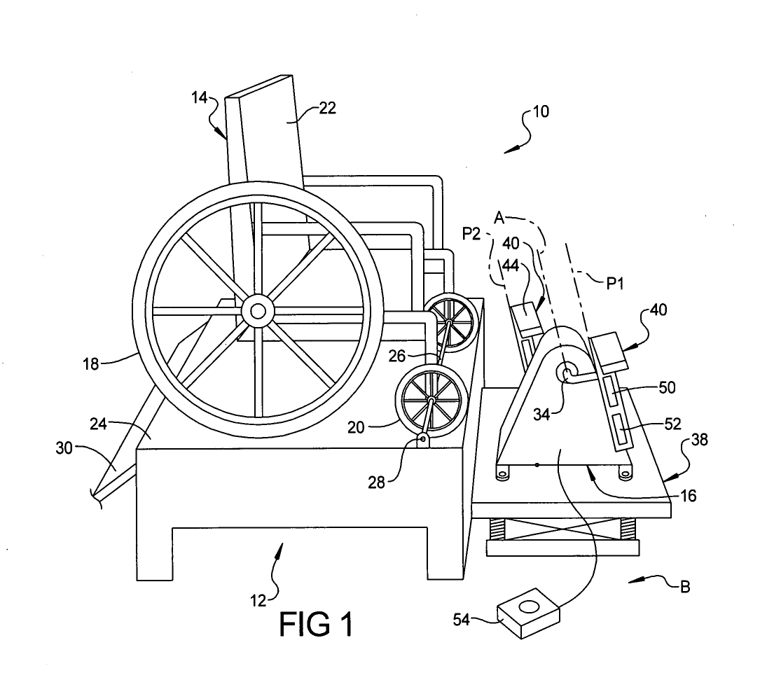

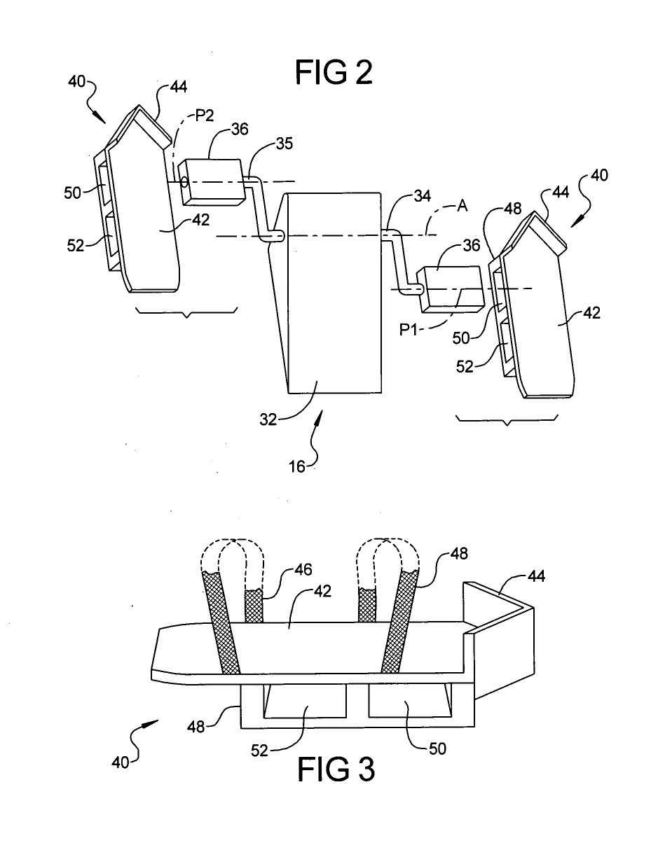

Turning now to the drawings, FIG. 1 illustrates exercise apparatus for providing both active and continuous passive motion of lower body extremities or legs or feet of a user, the apparatus being generally indicated by the reference numeral 10. The apparatus 10 includes a support stand 12 adapted to position a wheelchair or chair 14 relative to a pedaling exerciser 16. The wheelchair 14 is conventional and includes a pair of rear wheels 18, a pair of front wheels 20, and a seat portion 22.

In the embodiment illustrated, the support stand 12 includes a support surface 24 that supports the wheelchair 14 vertically above and slightly away from the pedaling exerciser 16. A securement rod 26 extends through the wheels 20 and has opposite ends thereof connected to respective brackets 28 on opposite lateral sides of the stand 12 wherein to secure the wheelchair 14 atop the support stand and position the lower front of the wheelchair in operable relation with the exerciser 16. While a rod 26 is shown, separate clamps and the like and associated brackets may be used to grip the wheels 18 and 20 and position the wheelchair 14 atop the support stand 12.

In some arrangements, one or more ramps 30 may be provided to permit the user to push the wheelchair 14 atop the stand 12. Other conventional wheelchair elevating apparatus may be used, depending on the installation.

The pedaling exerciser 16 includes a frame 32, a crankshaft 34 mounted for rotation to the frame, and a motor (not shown) for rotating the crankshaft. The crankshaft 34 has a pair of opposite ends 35 and a foot pedal 36 mounted on each respective end for rotation relative the connection. The pedals 36 and crankshaft 34 are arranged, much like a conventional bicycle. The ends 35 are in the form of generally axially elongated offset shafts that orbit about the axis of rotation “A” of the crankshaft. The pedals 36 are generally flat and rectangular in shape and have a center portion mounted for rotation relative to their respective end 35. That is, the pedal supporting ends 35 define axes of rotation “P1” and “P2” for the respective pedals 36, which axes are parallel to and radially spaced from the axis of rotation “A” of the crankshaft 34.

Important to this invention is that the active/passive apparatus 10 be adjustable, as to location of the pedaling exerciser 16 relative to the wheelchair 14 and the location of the feet of the user relative to the pedals 36 of the pedaling exerciser 16 wherein to accommodate feet or legs of different users in order that the user may work out the legs. That is, the active/passive apparatus 10 may be personalized to accommodate different users and provide a user with low impact work out or therapy exercise that is easy on the joints, promotes circulation, and is adjustable to provide different speeds to progressively strengthen arms and legs.

Additionally, a therapy exercise arrangement is provided wherein to adjustably position the feet of a user seated in a wheelchair with the pedals of an active/passive pedaling apparatus, the pedaling apparatus being stationary or movable both towards and away and/or vertically upwardly and downwardly relative to a platform upon which the wheelchair is secured.

According to this invention, because of the difference in users body types, height, and the like, and whether confined to the wheelchair 14 or other chair, the apparatus 10 preferably includes a lift 38 for positioning the pedaling exerciser 16 relative to the support stand 12 and the pedals 36 of the crankshaft 34 relative to the lower front end of the wheelchair 14. The exerciser 16 is secured atop the lift 38 by any conventional securement approach, consistent with the frame 32 of the exerciser 16.

The lift 38 is disposed on a ground plane “B” vertically below the support surface 24 of the support stand 12 and is movable vertically relative thereto. In some applications, the lift 38 is movable back and forth, generally horizontally, towards and away from the support stand 12. Such horizontal and vertical control of exerciser position enables the pedals 36 and the users feet to be more appropriately located for maximum therapy.

Further, and as an important feature of this invention, there is provided a pair of ankle strap sandals 40, one for each respective pedal 36 of the crankshaft 34. The sandals 40 are for restraining a respective foot of the user and each is selectively transversely positionable relative to the axis of rotation of the pedal to which attached. The foot restraining or securement arrangement is adjustable to ensure that the feet of the patient are maintained in alignment with the cycling motion.

According to this invention, each ankle strap sandal 40 comprises a longitudinally elongated planar platform 42 for supporting the base of the foot and an upstanding back 44 for nesting the ankle of the foot relative to the platform. As an aspect of this invention, the back 44 is generally V-shaped, to nest the ankle of the user and shoulder rearward forces occasioned during pedaling and acting to slide the foot longitudinally rearward. The back could be contoured or shaped as desired depending on the foot support desired.

As shown best in FIG. 3, a first and second strap 46 and 48 is provided for restraining and securely fastening the foot and ankle relative to the top surface of the platform 42 and the back 44 in a manner that the mid-point of the foot is disposed between the opposite ends of the platform 42. The straps secure the ankle firmly to the back 44 and the foot firmly atop the platform 42. While many possibilities are available and known to those skilled in the art, preferably the straps are flexible bands of hook and loop material, such as commercially available under the tradename Velcro®. The straps 46 and 48 would preferably have connectible free end portions to enable the foot to be firmly fitted and removed easily.

Importantly, the sandal 40 includes a multi-chambered connector base 48 for connecting the sandal to the pedal in a manner that the mid-point of the foot may be positioned where desired relative to the axis of rotation of the pedal wherein to orient the base of the foot and leg of the user in a manner to optimize the force transmitted to the leg and to exercise same upon rotation of the crank either actively by the user or passively by the motor. The base 48 depends downwardly from the bottom of the platform 42 and, in the embodiment illustrated, includes two chambers 50 and 52 in side-by-side relation and transverse to the longitudinal axis of the platform 42. The chambers 50 and 52 extend laterally between the side edges of the platform and each is adapted to be slipped over and be disposed in firm captivating engagement about a respective pedal. So fitted, the sandal 40 orients the longitudinal axis of the platform to be orthogonal to the axis of the crankshaft end. Depending on the chamber selected, the mid-point of the foot may be centered atop the crankshaft end, or longitudinally forward or rearward thereof.

Desirably, the therapy system of the wheelchair 14 being disposed above the pedaling exerciser 16 enables the user to establish a therapy regimen wherein substantially vertical movement of the leg is achieved, as opposed to horizontal translation. In this regard, the removable and positionable foot sandals 40 further complement the orientation of the leg and foot of the user relative to the pedal crank 34 of the exerciser 16.

Further, the apparatus 10 includes a controller 54 for selectively disabling the motor to permit a user to physically rotate the crank, and actively exercise their legs, without motor assistance, and enabling the motor to rotate the crank and passively exercise the legs of the user.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What I claim is:

1. An exercise apparatus for providing both active and continuous passive motion of lower body extremities or legs of a user, comprising
a pedaling exerciser, said exerciser including a frame, a crankshaft having opposite offset end portions, a pair of foot pedals, and a motor for rotating the crankshaft, said crankshaft mounted for rotation relative to the frame, and said foot pedals mounted on a respective end portion for rotation relative thereto,
a support stand to support a chair above and away from said exerciser and to position the feet and legs of the user relative to the pedals of said exerciser while seated in the chair, and
a pair of ankle strap sandals, said sandals respectively for one and the other of said pedals and restraining a respective foot of the user, each said sandal being connected to a respective of the pedals and selectively positionable relative to the axis of rotation of the pedal relative to the crankshaft end.

2. The apparatus of claim 1, wherein each ankle strap sandal comprises
a longitudinally elongated planar platform for supporting the base of the foot of the user and an upstanding back for nesting the ankle of the foot relative to the platform,
restraining means for securely fastening the foot and ankle relative to the platform and the back in a manner that the mid-point of the foot is disposed between the opposite longitudinal ends of the platform, and
means for connecting the sandal to the pedal in a manner that the mid-point of the foot may be positioned where desired relative to the axis of rotation of the pedal wherein to orient the base of the foot and leg of the user in a manner to optimize the force transmitted to the leg and to exercise same upon rotation of the crankshaft either actively by the user or passively by the motor.

3. The apparatus according to claim 2, wherein the means for connecting comprises provision of a multi-chambered connector base, the base depending from the bottom of the platform, and said chambers being spaced in side-by-side relation and extending transversely of the platform longitudinal axis and between the opposite sides of the platform.

4. The apparatus according to claim 3, wherein the chambers are adapted to be slipped over and mounted about a respective pedal and, so mounted, orient the longitudinal axis of the platform to be orthogonal to the axis of the crankshaft end portion about which fitted.

5. The apparatus according to claim 4, wherein depending on the chamber selected, the mid-point of the foot may be centered atop the crankshaft end, or longitudinally forward or rearward thereof.

6. The apparatus according to claim 1, further comprising a controller for selectively disabling the motor to permit a user to physically rotate the crank, and actively exercise their legs, without motor assistance, and enabling the motor to rotate the crank and passively exercise the legs of the user.

7. The apparatus according to claim 1, further comprising means for positioning the pedaling exerciser relative to said support stand and the pedal crankshaft relative to the chair, wherein to accommodate for the difference in users body types, height, and the like, and whether confined to a wheel chair or other chair.

8. The apparatus according to claim 7, wherein,
the support stand defines a first support surface for supporting the chair, which support surface is vertically above a horizontal ground plane, and
the means for positioning comprises a lift, and means for securing said exerciser atop said lift, said lift being disposed on and movable vertically relative to said ground plane.

9. The apparatus according to claim 8, wherein the means for positioning is configured that the lift is movable back and forth, generally horizontally, towards and away from said support stand, wherein such horizontal and vertical control of the position of the pedaling exerciser enables the pedals and the users feet to be more appropriately located for maximum therapy.

10. The apparatus according to claim 1, wherein the therapy system of the wheelchair is disposed above the pedaling exerciser in a manner that enables vertical movement of the leg, as opposed to horizontal translation.

11. The apparatus according to claim 10, wherein the removable foot sandal further complements the orientation of the leg and foot of the user relative to the pedal crank of the exerciser.

12. The apparatus according to claim 1 wherein the ankle strap sandals includes a back that is substantially V-shaped wherein to nest the ankle of the user, and further includes securement straps to secure the ankle firmly to the back and the foot firmly atop the platform.
